(19) United States
(12) Patent Application Publication
(10) Pub. No.: US 2008/0141376 A1
(43) Pub. Date: Jun. 12, 2008

(54) DETERMINING MALICIOUSNESS OF SOFTWARE

(75) Inventors: Simon Clausen, Balmain (AU); Rolf Repasi, Sunrise Beach (AU); Kien Sen Huang, Riverwood (AU)

Correspondence Address: WORKMAN NYDEGGER, 60 EAST SOUTH TEMPLE, 1000 EAGLE GATE TOWER, SALT LAKE CITY, UT, 84111, US

(73) Assignee: PC TOOLS TECHNOLOGY PTY LTD., Melbourne (AU)

(21) Appl. No.: 11/877,284

(22) Filed: Oct. 23, 2007

Related U.S. Application Data
(60) Provisional application No. 60/862,681, filed on Oct. 24, 2006.

(30) Foreign Application Priority Data
Oct. 24, 2006 (AU) 2006905924

(51) Int. Cl. G06F 11/00

(52) U.S. Cl. 726/24

(57) ABSTRACT

A method of detecting malicious activity, including the steps of: intercepting activity in a processing system 100; detecting attributes of an un-assessed process 460 associated with the activity; comparing the process attributes and activity to a database 430 of attributes and activity associated with known malicious and non-malicious processes; and using an inference filter 470 to compute the likely maliciousness of the un-assessed process.

### TECHNICAL FIELD

The present invention generally relates to a method, system, computer readable medium of instructions and/or computer program product for determining the maliciousness of software.

### BACKGROUND ART

Malicious software, also known as “malware” or “pestware”, includes software that is included or inserted in a part of a processing system for a harmful purpose. Types of malware can include, but are not limited to, malicious libraries, viruses, worms, Trojans, malicious active content and denial of service attacks. In the case of invasion of privacy for the purposes of fraud or the theft of identity, malicious software that passively observes the use of a computer is known as “spyware”.

There are currently a number of techniques which can be used to detect malicious activity in a processing system. One technique includes using database driven malware techniques which detect known malware. In this technique, a database is used which generally includes a signature indicative of a particular type of malware. However, this technique suffers from a number of disadvantages. Generating and comparing signatures for each entity in a processing system to the database can be highly process-intensive task. Other applications can be substantially hampered or can even malfunction during this period of time when the detection process is performed. Furthermore, this technique can only detect known malware. If there is no signature in the database for a new type of malware, malicious activity can be performed without the detection of the new type of malware.

A related technique is virtual machine scanning which uses database driven malware techniques in a virtual environment. Virtual machine scanning operates by executing processes inside a virtual machine and then monitoring actions performed by the process. A database contains lists of actions which are deemed suspicious. If the process performs one or more of the known suspicious actions then it is flagged as malicious. Once again, this technique is highly resource intensive and not well suited to real-time protection but only scanning of the processing system.

Another method that can be used includes a dynamic detection technique to detect malicious activity in a processing system. In this technique, particular events are recorded which are generally associated with the behaviour of malware. The recorded events are then analysed to determine whether the events are indicative of malicious activity. Thus, new types of malware can be detected if they perform behaviour which is generally considered malicious. However, this activity suffers from high inefficiency due to recording “false positives”. For example, if the user interacts with the operating system to cause a permission of a file to change, this event would be recorded and would be analysed, thereby wasting processing resources.

Yet another method that can be used involves the monitoring of key load points in a processing system. When a process modifies or is about to modify any of the key areas which are usually used by malware to install themselves, the user is either prompted or the application is blocked. However, many legitimate applications utilize key load points and accordingly this technique also produces false positives or alerts, which can confuse the user.

Therefore, there exists a need for a method, system, computer readable medium of instructions, and/or a computer program product which can efficiently determine the maliciousness of software which addresses or at least ameliorates at least one of the problems inherent in the prior art.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

### DISCLOSURE OF INVENTION

In a first broad form, the present invention provides a method of detecting malicious activity, including the steps of: intercepting activity in a processing system; detecting attributes of an un-assessed process associated with the activity; comparing the process attributes and activity to a database of attributes and activity associated with known malicious and non-malicious processes; and using an inference filter to compute the likely maliciousness of the un-assessed process.

Preferably, a minimum number of attributes of un-assessed processes are detected before the process attributes and activity of the un-assessed processes are compared with attributes and activity associated with known malicious and non-malicious processes.

Preferably, if the inference filter computes that the un-assessed process is likely to be malicious, the method further includes the step of terminating the un-assessed process associated with the activity.

Preferably, if the inference filter computes that the un-assessed process is likely to be malicious, the method further includes the step of deleting a file associated with the un-assessed process run by the activity.

Preferably, if the inference filter computes that the un-assessed process is likely to be malicious, the method further includes the step of notifying a user.

In one particular, but non-limiting form, the method further includes the step of notifying a communications module after the inference filter computes the un-assessed process to be a likely malicious process or non-malicious process.

Preferably, the communications module is in communication with an administrator and notifies the administrator if the un-assessed process was computed by the inference filter to be a likely malicious process or non-malicious process.

Preferably, the communications module is in communication with a third party and notifies the third party if the un-assessed process was computed by the inference filter to be a likely malicious process or non-malicious process. The third party may be a remote database operated by a vendor.

In another particular, but non-limiting form, the communications module provides the remote database with user information, process information and a user response. The process information and user response may be exchanged between other users via the remote database. The exchange may take place after the user executes the method of claim 1. Alternatively, the exchange may take place automatically at periodic intervals. In a further alternative, the exchange may take place when new software is installed by the user. The communications module may update the database as determined by user response.

Preferably, once the inference filter computes the likely maliciousness of the un-assessed process, the database is amended if a user considers that the un-assessed process is a malicious process or non-malicious process.

In a second broad form, the present invention provides a method of training an inference filter for use in a method of detecting malicious activity according to the first broad form of the invention, including the steps of: loading and running known malicious and known non-malicious software into a processing system; intercepting activity by the known malicious and known non-malicious software in a processing system; detecting attributes of one or more processes associated with the activity by the known malicious and known non-malicious software; storing process attributes and activity in a database; advising the inference filter if the attributes of one or more processes associated with activity are malicious or non-malicious.

Preferably, the malicious and non-malicious software is loaded manually into the processing system by a user. Alternatively, the malicious and non-malicious software is loaded automatically by a loader into the processing system. In a further alternative, the malicious and non-malicious software is loaded automatically by a loader which services a queue populated by a local or remote service. The local or remote service may be a web crawler.

Preferably, the malicious and non-malicious activities are intercepted by API hooking techniques.

Preferably, the attributes of one or more processes associated with the activity by the known malicious and known non-malicious software are stored in a separate portion of the database.

Alternatively, the attributes of one or more processes associated with the activity by the known malicious and known non-malicious software are stored in a separate database.

In a third broad form, the present invention provides software for use with a computer including a processor and associated memory device for storing the software, the software including a series of instructions to cause the processor to carry out a method according to the first and second broad forms of the invention.

Preferably, the software resides in a virtual environment. Preferably, the virtual environment is a virtual machine. Preferably, the software resides in a revertible physical machine.

### BRIEF DESCRIPTION OF FIGURES

An example embodiment of the present invention should become apparent from the following description, which is given by way of example only, of a preferred but non-limiting embodiment, described in connection with the accompanying figures.

FIG. 1 illustrates a functional block diagram of an example of a processing system that can be utilised to embody or give effect to a particular embodiment;

FIG. 2 illustrates a block diagram illustrating the relationship between a requesting entity and a target entity;

FIG. 3 illustrates a flow diagram of an example method of intercepting an activity in a processing system;

FIG. 4 illustrates a functional block diagram of the malicious software detection system;

FIG. 5 illustrates a flow diagram of the method of training an inference filter to detect malicious software; and

FIG. 6 illustrates a flow diagram of the method of operation of the malicious software detection system.

### MODES FOR CARRYING OUT THE INVENTION

The following modes, given by way of example only, are described in order to provide a more precise understanding of the subject matter of a preferred embodiment or embodiments.

In the figures, incorporated to illustrate features of an example embodiment, like reference numerals are used to identify like parts throughout the figures.

### Example of a Processing System

A particular embodiment of the present invention can be realised using a processing system, an example of which is shown in FIG. 1. The processing system 100 illustrated in relation to FIG. 1 can be used as a client processing system and/or a server processing system. In particular, the processing system 100 generally includes at least one processor 102, or processing unit or plurality of processors, memory 104, at least one input device 106 and at least one output device 108, coupled together via a bus or group of buses 110. In certain embodiments, input device 106 and output device 108 could be the same device. An interface 112 can also be provided for coupling the processing system 100 to one or more peripheral devices, for example interface 112 could be a PCI card or PC card. At least one storage device 114 which houses at least one database 116 can also be provided. The memory 104 can be any form of memory device, for example, volatile or non-volatile memory, solid state storage devices, magnetic devices, etc. The processor 102 could include more than one distinct processing device, for example to handle different functions within the processing system 100. The memory 104 typically stores an operating system to provide functionality to the processing system 100. A file system and files are also typically stored on the storage device 114 and/or the memory 104.

Input device 106 receives input data 118 and can include, for example, a keyboard, a pointer device such as a pen-like device or a mouse, audio receiving device for voice controlled activation such as a microphone, data receiver or antenna such as a modem or wireless data adaptor, data acquisition card, etc. Input data 18 could come from different sources, for example keyboard instructions in conjunction with data received via a network. Output device 108 produces or generates output data 120 and can include, for example, a display device or monitor in which case output data 120 is visual, a printer in which case output data 120 is printed, a port for example a USB port, a peripheral component adaptor, a data transmitter or antenna such as a modem or wireless network adaptor, etc. Output data 120 could be distinct and derived from different output devices, for example a visual display on a monitor in conjunction with data transmitted to a network. A user could view data output, or an interpretation of the data output, on, for example, a monitor or using a printer. The storage device 114 can be any form of data or information storage means, for example, volatile or non-volatile memory, solid state storage devices, magnetic devices, etc.

In use, the processing system 100 can be adapted to allow data or information to be stored in and/or retrieved from, via wired or wireless communication means, the at least one database 116. The interface 112 may allow wired and/or wireless communication between the processing unit 102 and peripheral components that may serve a specialized purpose. The processor 102 receives instructions as input data 118 via input device 106 and can display processed results or other output to a user by utilising output device 108. More than one input device 106 and/or output device 108 can be provided. It should be appreciated that the processing system 100 may be any form of terminal, server processing system, specialised hardware, computer, computer system or computerised device, personal computer (PC), mobile or cellular telephone, mobile data terminal, portable computer, Personal Digital Assistant (PDA), pager or any other similar type of device.

The processing system 100 may be a part of a networked communications system. The processing system 100 could connect to network, for example the Internet or a WAN. The network can include one or more client processing systems and one or more server processing systems, wherein the one or more client processing systems and the one or more server processing systems are forms of processing system 100. Input data 118 and output data 120 could be communicated to other devices via the network. The transfer of information and/or data over the network can be achieved using wired communications means or wireless communications means. The server processing system can facilitate the transfer of data between the network and one or more databases.

### Target and Requesting Entities

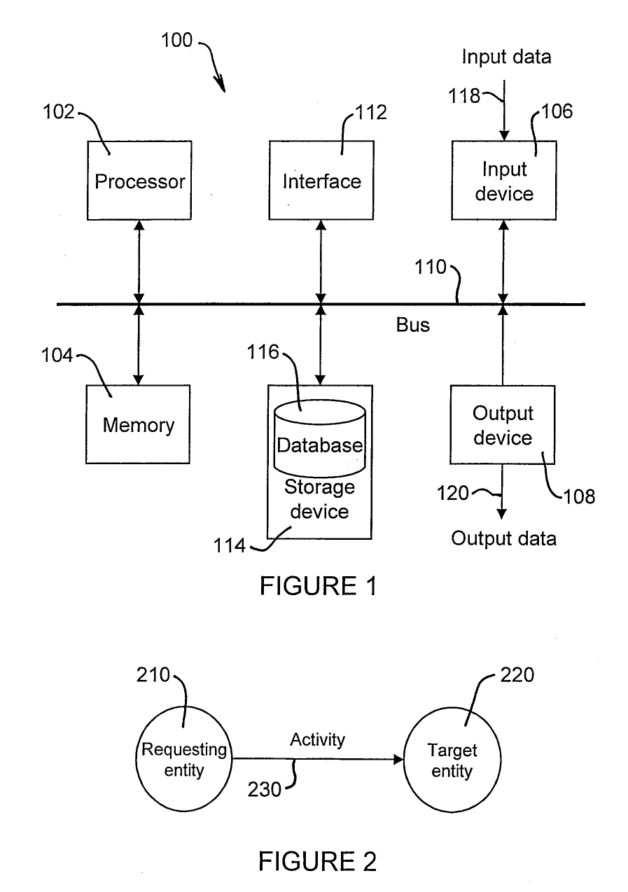

Referring to FIG. 2, there is shown a block diagram illustrating the relationship between a requesting entity 210 and a target entity 220. In particular, the requesting entity causes an activity 230 to be performed in relation to a target entity 220. For example, an executable object in a client processing system may request to download data from a web-site on the Internet. In this example, the executable object would be considered the requesting entity 210, the activity 230 would be considered the action of downloading data, and the target entity 220 would be the web-site on the Internet. The requesting entity 210 is a starting point in the processing system, or network of processing systems 100, which requests the activity 230 to be performed, and the target entity 220 is an end point in the processing system 100, or network of processing systems 100, which the activity 230 occurs in relation to.

### Interception

A hook (also known as a hook procedure or hook function), as used herein, generally refers to a callback function provided by a software application that receives certain data before the normal or intended recipient of the data. A hook function can thus examine or modify certain data before passing on the data. Therefore, a hook function allows a software application to examine data before the data is passed to the intended recipient.

An API (“Application Programming Interface”) hook (also known as an API interception), as used herein as a type of hook, refers to a callback function provided by an application that replaces functionality provided by an operating system's API. An API generally refers to an interface that is defined in terms of a set of functions and procedures, and enables a program to gain access to facilities within an application. An API hook can be inserted between an API call and an API procedure to examine or modify function parameters before passing parameters on to an actual or intended function. An API hook may also choose not to pass on certain types of requests to an actual or intended function.

A hook chain as used herein, is a list of pointers to special, application-defined callback functions called hook procedures. When a message occurs that is associated with a particular type of hook, the operating system passes the message to each hook procedure referenced in the hook chain, one after the other. The action of a hook procedure can depend on the type of hook involved. For example, the hook procedures for some types of hooks can only monitor messages, others can modify messages or stop their progress through the chain, restricting them from reaching the next hook procedure or a destination window.

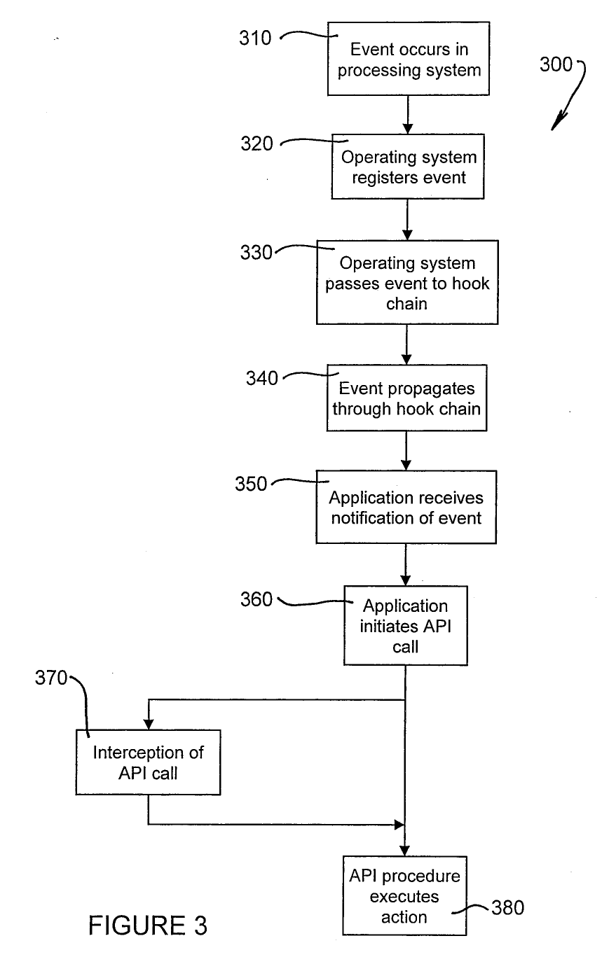

Referring to FIG. 3, there is shown an example of a method 300 of intercepting an activity in the processing system 100. At step 310, an event occurs in the processing system 100. The event can be a request by a requesting entity 210 to perform an action 230 in relation to a target entity 220. At step 320, an operating system running in the processing system 100 registers the occurrence of the event. At step 330, the operating system passes the registered event to the hook chain. At step 340, the event is passed to each hook in the hook chain such that different applications, processes, and devices may be notified of the registered event. Once the event has propagated throughout the hook chain, the method 300 includes at step 350 an application receiving notification of the event being registered by the processing system 100.

At step 360, the method 300 includes the application initiating an API call to an API procedure so as to carry out a response to the registered event, wherein the response may be the execution of the action 230 in relation to the target entity 220. If an API hook has been established between the API call and the API procedure, the API call is intercepted before it reaches the API procedure at step 370. Processing can be performed once the API call has been intercepted prior to the API procedure being called. The API call may be allowed to continue calling the API procedure at step 380 such that the action 230 is performed in relation to the target entity 220.

### Filter Training

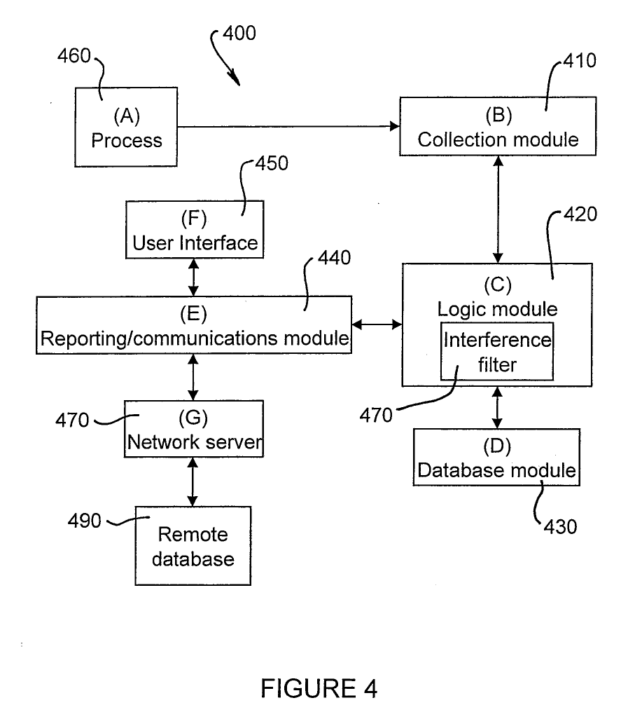

Referring now to FIG. 4, there are shown selected functional modules of a malicious software detection system 400. The functional modules shown in this figure are a collection module 410, a logic module 420, a database module 430, a reporting/communications module 440 and a user interface module 450. The functional modules 410 to 450 may be implemented separately as stand-alone software or in combination with currently known systems/methods as a software package. When implemented as a software package, the functional modules can be used to detect malicious software in the processing system 100.

The collection module 410 acts to monitor activity of processes running in the processing system 100, such as that caused by the exemplary process 460. The term “activity” is intended to encompass an event which has occurred and/or an action which is to be performed by a process in the processing system 100. A “process”, as used herein, is intended to encompass at least one of a running software program or other computing operation, or a part of a running software program or other computing operation, which performs a task.

The activities and the attributes of processes running in the processing system 100 are detected by the collection module 410 using API hooking techniques as described above. Exemplary activities and process attributes that may be monitored are listed in Table 1 below.

TABLE 1

| I. | Is (A)'s user interface visible and/or accessible? | |
|---|---|---|
| II. | Has (A) accessed or modified any of the system loadpoints? | |
| | If so, which ones | |
| III. | File system locations accessed (files read and created) | |
| IV. | Kernel mode drivers installed | |
| V. | Kernel mode drivers removed | |
| VI. | Kernel mode drivers communicated with | |
| VII. | System libraries installed (this includes registered | |
| | activex/OCX) | |
| VIII. | System libraries utilized | |
| IX. | System libraries removed | |
| X. | Services installed | |
| XI. | Services started | |
| XII. | Services stopped | |
| XIII. | Services removed | |
| XIV. | Access/modification of physical memory | |
| | i. | Is (A)'s user interface visible and/or accessible? |
| | ii. | Has (A) accessed or modified any of the system |
| | loadpoints? If so, which ones? | |
| | iii. | File system locations accessed (files read and created) |
| | iv. | Kernel mode drivers installed |
| XV. | Local network access | |
| XVI. | Remote network access (for example, when downloading | |
| | a file) | |
| XVII. | Local network server socket initialized (listening on an | |
| | unroutable address) | |
| XVIII. | Remote network server socket initialized | |
| XIX. | Reading of which processes memory | |
| XX. | Writing to which processes memory (i.e code injection) | |
| XXI. | Execution of which processes | |
| XXII. | Termination of which processes | |
| XXIII. | Executable file properties: | |
| | i. | Is it codesigned? |
| | ii. | Does it contain vendor info? (version info resource) |
| | iii. | Is it packed? |
| | iv. | Does it contain any suspect PE sections? |
| XXIV. | Modification of privileges on core system objects. | |
| XXV. | Modification of memory/structures in the kernel space. | |
| XXVI. | Location process executed from, eg: | |
| | i. | Removable media |
| | ii. | Temporary folders |
| | iii | System folders, etc |
| XXVII. | Hardware access (both read/write), eg: | |
| | i. | Keyboard |
| | ii. | Mouse |
| | iii. | Flashable BIOSes |

| | |
|---|---|
| XXVIII. | Does the process restart itself when forcefully terminated? |

The collection module 410 acts to passes data about the activities and attributes of processes running in the processing system 100 to the logic module 420 which converts this data into a format suitable for transmission to the database module 430. The database module 430 stores historically collected process attribute and event data. The logic module 420 includes an inference filter 470 that uses the data stored in the database module 430 to determine the likelihood of an unknown process causing an activity to be performed being malicious or non-malicious. In this embodiment, the inference filter 470 forms part of the logic module 430 but in other embodiments the inference filter may be realized as a stand alone module.

In this exemplary case, the inference filter 470 applies Bayes' theorem to classify an unknown process by monitoring the activities and attributes of that process and comparing those activities and attributes to those of processes known to be either malicious or non-malicious. Bayes' theorem can be applied in the context of malicious software detection, whereby the probability Pr(malware|behaviours) that the software is malicious, given that it has certain behaviours, namely the activities and attributes of that piece of software, is equal to the probability Pr(behaviours|malware) of finding those certain behaviours in malicious software, times the probability Pr(malware) that any software is malicious, divided by the probability Pr(behaviours) of finding those behaviours in any software application, namely

$$Pr ( malware \vert behaviours ) = \frac{Pr ( behaviours \vert malware ) * Pr ( malware )}{Pr ( behaviours )} .$$

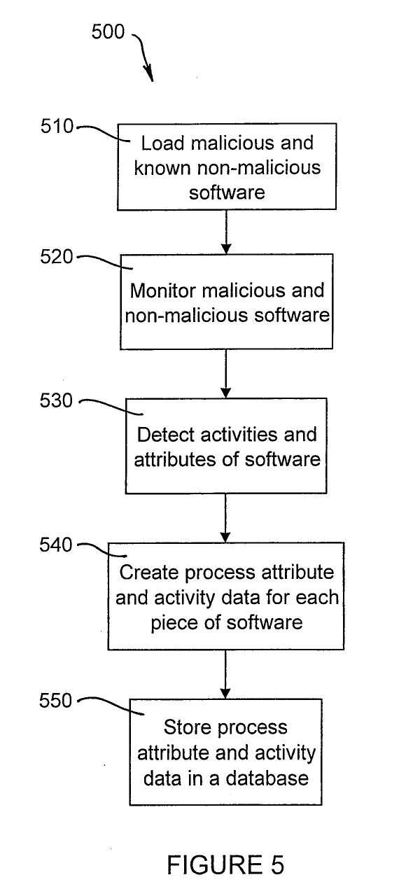

Referring to FIG. 5, the flow chart 500 illustrates an exemplary method of training the inference filter 470 to predict whether an unknown process is malicious or not malicious with a low likelihood of false positives. At step 570, known malicious and non-malicious software is loaded into the malicious software detection system 400 of FIG. 4. The known malicious software may be software that is detected as malicious by anti-virus software, anti-spyware software or a human who has manually analysed the software in question. The known non-malicious software may include off the shelf software such as Office software and image editing suites. Alternatively, known non-malicious software may be determined as non-malicious by the software not being detected by Anti-Virus software, or not being detected by Anti-Spyware software or not being detected as malicious by a human who has manually analysed the software in question.

The known malicious and non-malicious software may be loaded into the malicious software detection system 400 manually by an operator, or may be loaded automatically by a loader which services a queue maintained by a number of remote operators or may be loaded automatically by a loader which services a queue populated by a local or remote service such as a web crawler. A remote operator may be a malware analyst. The malware analyst may maintain the queue by helping to classify the known malicious and non-malicious software. The malware analyst may also change priorities when loading the known malicious and non-malicious software (for example adding software to the start of the queue or removing software from the queue). The malware analyst may also add comments or descriptions associated with the known malicious and non-malicious software which may then be stored in the database module 430. Alternatively, the known malicious and non-malicious software may be loaded by a combination of the above techniques.

As each piece of known malicious and non-malicious software is loaded into the malicious software detection system 400, the activities and attributes associated with that software are monitored at step 520 by the collection module 410 utilizing API hooking techniques as described above. Typically, around one thousand of the most common pieces of known malicious software and known non-malicious software may be loaded into the system 400 in order to adequately train the inference filter 470, but this number may vary according to the nature of the inference filter. As the software runs, the activities and attributes of the software are detected by the collection module 410 at step 530. Attribute and activity data characterizing each known process is then created by the logic module 470 at step 540 and transmitted to the database module 430 for storage at step 550.

A portion of the database module 430 is set aside for attribute and activity data relating to known malicious processes, whilst another portion of the database is set aside for attribute and activity data relating to known non-malicious processes. Alternatively, two separate database modules may be utilized. The process attribute and activity data stored in the database 430 may be weighted according to the frequency with which each activity or attribute is found to occur for known malicious and/or non-malicious processes. The process attribute and activity data may also be weighted according to the type of activity or attribute in question. For example, known malicious software that restarts itself when forcefully terminated may be given a higher weighing than known malicious software that is executed in a temporary folder.

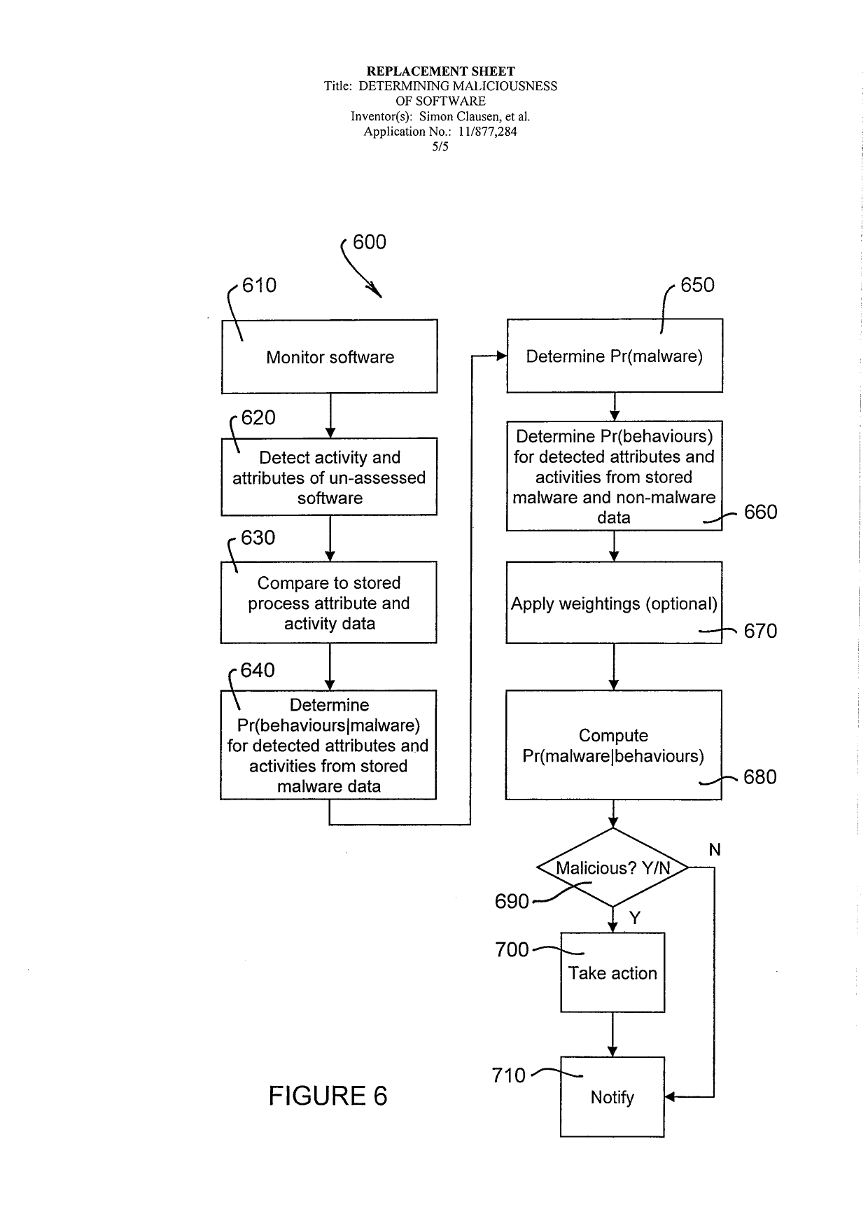

Referring to FIG. 6, there is shown a flow chart 600 illustrating a method of using the system 400 shown in FIG. 4 to detect the maliciousness of an unknown piece of software. Activities occurring within the processing system 100 are monitored by the malicious software detection system 400 at step 610. Upon occurrence of each activity, the attributes of the process associated with that activity, together with the activity itself, is captured by the collection module 410 at step 620. The detected process attribute and activity data is then forwarded to the logic module 420 for analysis. At step 630, the process attribute and activity data captured by the collection module 410 is then compared by the logic module 420 to historically recorded process attribute and activity data for known malicious and non-malicious processes.

The inference filter 470 then acts to determine the likelihood of the process associated with the detected activity and attributes being malicious software. Accordingly, at step 640, the inference filter determines the probability Pr(behaviours|malware) of the detected behaviours, namely the activities and attributes of the process associated therewith, occurring in malware by examining the attributes and activities recorded for known malicious software during the training process described in FIG. 5.

At step 650, the inference filter 470 then determines the probability Pr(malware) that any process is malicious software by examining the stored process attribute and activity data for both malicious and non-malicious software maintained in the database module 430.

At step 660, the inference filter 470 then determines the probability Pr(behaviours) that the detected attributes and activities occur in any process by examining the stored process attribute and activity data for both malicious and non-malicious software maintained in the database module 430.

At step 670, the inference filter 470 may optionally apply weightings to the process attribute and activity data stored in the database 430 according to their frequency of occurrence in the recorded data maintained in the database module 430, and/or according to the type of activity or attribute in question.

At step 480, the computations carried out in steps 640 to 670 are used to compute the probability Pr(malware|behaviours) of the software associated with the activity detected in step 610 being malicious.

At step 690, the logic module 420 makes a determination as to whether the probability calculated in step 680 exceeds a predetermined threshold indicative that the detected process is malicious software. If this is the case, then the logic module 420 may act at step 700 to terminate the unaccessed process or delete a file associated with that process. The logic module 420 may additionally or alternatively contact the communications module 440 so that a notification may be forwarded to a user at step 710.

If it is determined at step 690, however, that the process monitored at step 610 is likely to be non-malicious software, then no action need be taken and a notification can be forwarded to the user at step 710 only. Notification that the detected process is either malicious or non-malicious software may be forwarded to the user via the user interface 450. The user may use this interface to optionally terminate an unaccessed process or delete a file associated with the process or override a result and retain an unaccessed process. The result of any user action may be reported back to the communications module 440 and the logic module 420 for updating of the database module 430.

If the unknown process was found at step 690 to be likely to be malicious, the reporting/communications module 440 may use the network server 470 to contact an administrator. Alternatively, the reporting/communications module 440 may use a network server 480 to update a remote database 490 operated by a vendor. The vendor may be a malicious software solution vendor. The information submitted to the malicious software solution vendor may include:
User profile information such as username, cookies, password or serial number.
Process information such as name, checksum, cryptographic hashes and full or partial file contents.
User response to a prompt.

The reporting/communications module 440 may act to update the database module 430 based on the result at step 690 or in response to a user response via the user interface 430. For example, if the unknown process was determined at step 690 to be malicious but the user response via the user interface 450 indicated that it was not, then the reporting/communications module 440 may report this result to the database module 430 via the logic module 420 that data characterising the process should be placed into the portion of the database module 430 which is reserved for known non-malicious software.

The remote database may be connected to a wide area network such as the Internet, via the network server 480. The reporting/communications module 440 may be in communication with the remote database 490 via the network server 480. Users of the malicious software detection system 400 may participate in an online environment where settings and database entries in the database module 430 may be exchanged. The exchanges may take place automatically or manually or once a user has one or more entries added to the database module 430. Alternatively, exchanges may take place immediately after a user installs the unknown software and the malicious software detection system 400 is executed on the processing system 100. In this case, the reporting/communications module 440 queries the network server 480 for any entries relevant to the user. Exchanges may take place automatically at set time intervals. Alternatively, exchanges may take place once certain conditions have been met, for example, when new unknown software has been installed or the user overrides the result of the malicious software detection system 400.

In a further alternative, the malicious software detection system 400 may scan a users computer to determine whether entries in the database module 430 are relevant to the user. This information may then be passed from the network server 480 which in turn returns rule entries submitted by other users which are relevant to the installed software on the users' computer.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although a preferred embodiment has been described in detail, it should be understood that various changes, substitutions, and alterations can be made by one of ordinary skill in the art without departing from the scope of the present invention. For example, to avoid misclassification, a minimum number of activities and attributes of unknown processes may be detected before these behaviours are compared with attributes and activity associated with known malicious and non-malicious processes to determine the likelihood of that process being malicious.

1. A method of detecting malicious activity, including the steps of:
intercepting activity in a processing system;
detecting attributes of an un-assessed process associated with the activity;
comparing the process attributes and activity to a database of attributes and activity associated with known malicious and non-malicious processes; and
using an inference filter to compute the likely maliciousness of the un-assessed process.

2. The method of claim 1, wherein a minimum number of attributes of un-assessed processes are detected before the process attributes and activity of the un-assessed processes are compared with attributes and activity associated with known malicious and non-malicious processes.

3. The method of claim 1, wherein if the inference filter computes that the un-assessed process is likely to be malicious, the method further includes the step of terminating the un-assessed process associated with the activity.

4. The method of claim 1, wherein if the inference filter computes that the un-assessed process is likely to be malicious, the method further includes the step of deleting a file associated with the un-assessed process run by the activity.

5. The method of claim 1, wherein if the inference filter computes that the un-assessed process is likely to be malicious, the method further includes the step of notifying a user.

6. The method of claim 1, wherein the method further includes the step of notifying a communications module after the inference filter computes the un-assessed process to be a likely malicious process or non-malicious process.

7. The method of claim 6, wherein the communications module is in communication with an administrator and notifies the administrator if the un-assessed process was computed by the inference filter to be a likely malicious process or non-malicious process.

8. The method of claim 6, wherein the communications module is in communication with a third party and notifies the third party if the un-assessed process was computed by the inference filter to be a likely malicious process or non-malicious process.

9. The method of claim 8, wherein the third party is a remote database operated by a vendor.

10. The method of claim 9, wherein the communications module provides the remote database with user information, process information and a user response.

11. The method of claim 10, wherein the process information and user response is exchanged between other users via the remote database.

12. The method of claim 11, wherein the exchange takes place after the user executes the method of claim 1.

13. The method of claim 12, wherein the exchange takes place automatically at periodic intervals.

14. The method of claim 12, wherein the exchange takes place when new software is installed by the user.

15. The method of claim 10, wherein whether the communications module updates the database is determined by user response.

16. The method of claim 1, wherein once the inference filter computes the likely maliciousness of the un-assessed process, the database is amended if a user considers that the un-assessed process is a malicious process or non-malicious process.

17. A method of training an inference filter for use in a method of detecting malicious activity according to claim 1, including the steps of:
loading and running known malicious and known non-malicious software into a processing system;
intercepting activity by the known malicious and known non-malicious software in a processing system;
detecting attributes of one or more processes associated with the activity by the known malicious and known non-malicious software;
storing process attributes and activity in a database;
advising the inference filter if the attributes of one or more processes associated with activity are malicious or non-malicious.

18. The method of claim 17, wherein the malicious and non-malicious software is loaded manually into the processing system by a user.

19. The method of claim 17, wherein the malicious and non-malicious software is loaded automatically by a loader into the processing system.

20. The method of claim 17, wherein the malicious and non-malicious software is loaded automatically by a loader which services a queue populated by a local or remote service.

21. The method of claim 1 or 17, wherein the malicious and non-malicious activities are intercepted by API hooking techniques.

22. Software for use with a computer including a processor and associated memory device for storing the software, the software including a series of instructions to cause the processor to carry out a method according to any one of claims 1 or 17.

23. The software of claim 23, wherein the software resides in a virtual environment.

24. The software of claim 22, wherein the virtual environment is a virtual machine.

25. The software of claim 22, wherein the software resides in a revertible physical machine.
